(19) United States
(12) Patent Application Publication
(10) Pub. No.: US 2022/0219369 A1
(43) Pub. Date: Jul. 14, 2022

(54) Extrusion cylinder with means for conducting cooling or heating medium

(71) Applicant: KRAUSSMAFFEI EXTRUSION GMBH, Hannover (DE)

(72) Inventors: Christian Gerjet Plinke, Hannover (DE); Vanessa Stäbe, Barsinghausen (DE); Jaspa Lyon Tietz, Hannover (DE)

(21) Appl. No.: 17/604,007

(22) PCT Filed: Apr. 8, 2020
(86) PCT No.: PCT/EP2020/059989

§ 371 Date: Oct. 15, 2021

(30) Foreign Application Priority Data
Apr. 24, 2019 (DE) 10 2019 110 576.5

(51) Int. Cl. B29C 48/80; B29C 48/68; B29C 48/25

(52) U.S. Cl. CPC B29C 48/83; B29C 48/2565; B29C 48/6801

(57) ABSTRACT

An extrusion cylinder has a cylinder body for accommodating an extruder worm and is characterized in that an outer wall of the cylinder body has at least one depression which can be covered and which in the covered state is suitable for conducting a cooling or heating medium for controlling the temperature of the cylinder body.

The present invention relates to extrusion cylinders which can be temperature-controlled in an effective manner, and production methods for such extrusion cylinders.

In the field of extrusion, it is often necessary to control the temperature of extrusion cylinders which are used for the conducting and mixing of extrudate, in which the extruder worm circulates the extrudate. In particular in rubber extrusion it is advantageous to firstly pre-heat the extrusion cylinder in order to bring the extrudate more quickly into a plastically deformable state. In the further process, however, the heat generated during the conducting/mixing of the extrudate must be partially dissipated again. Usually, a cooling or respectively heating means such as e.g. water or suchlike is used here, which is conducted via ducts to the extrusion cylinder and serves as a heat exchanger.

In order to configure the heat exchange in as effective manner as possible, it is recommended to bring the heat exchanger into direct contact with the cylinder body. For this, currently peripheral bores through the cylinder are used. As it is not possible, however, to execute such deep hole bores for large bore depths with sufficient accuracy, the axial length of cylinder bodies provided with peripheral bores is limited. As extrusion cylinders typically have a greater length than can be dealt with by means of peripheral bores, it is necessary to assemble an extrusion cylinder from several individual parts. This takes place by connection flanges at the ends of the individual cylinder segments.

In addition to the high manufacturing- and assembly costs of this system of cylinder segments, further problems occur in addition.

On the one hand, it is desirable to prevent pressure losses of the temperature control medium due to deflections which are too intensive in the temperature control channels. In the case of the currently used bores, this can not be accomplished, however. Rather, sudden deflections of 180° often occur within the connection flanges. Also, no closed routing is present within the temperature control system. Rather, this is segmented into several circuits with undirected flow. The temperature control is hereby difficult to govern and control and must be carried out under high pressure.

A further problem consists in that a distribution of different temperature control zones, therefore the setting of different temperatures along the extrusion cylinder, must be oriented to the length of the individual cylinder segments. A free creation and positioning of temperature zones is not possible.

Also for the mixing of extrudate with relatively high viscosity, such as of rubber for instance, it is advantageous to screw pins from the exterior into the interior of the extrusion cylinder. These pins project into the extrudate and, in interaction with the movement of the extruder worm, promote the mixing and plasticizing of the extrudate. For an optimum effect, these pins should be distributed as uniformly as possible over the length of the extrusion cylinder. However, if the latter is divided into several segments which are connected by flanges, no pins can be inserted in the region of the flanges. Hereby, the extrusion process can slow down or even worsen.

The currently used temperature control systems for extrusion cylinders therefore lead to a deficient flexibility with regard to the temperature-controllability of the cylinders and with regard to the arrangement of pins in the cylinder which are advantageous for the mixing of the extrudate. In addition, the production of an extrusion cylinder made of several segments provided with deep hole bores is prone to error and is costly. Owing to the high pressure loss in the bores and the undirected conducting of flow, the operation of such temperature control systems is also expensive.

It is an object of the present invention to indicate an extrusion cylinder by which at least a portion—preferably all—of the above-mentioned problems are solved. In addition, it is an object of the present invention to indicate a production method for such an extrusion cylinder.

This problem is solved by the subject of the independent claims.

An extrusion cylinder can have a cylinder body for accommodating an extruder worm, which is characterized in that an outer wall of the cylinder body has at least one depression which can be covered and which in the covered state is suitable for conducting a cooling or heating medium for controlling the temperature of the cylinder body.

Instead of providing bores in the interior of the cylinder body, depressions are therefore produced in the outer wall of the cylinder body, for example by the milling of one or more continuous grooves into the outer wall of the cylinder body. These depressions must be dimensioned here in such a manner that a cooling or heating medium which is able to be used for the temperature control of the cylinder body, such as for instance water or a similar heat-exchanging fluid, can flow through the depression without excessive pressure loss, when this depression is covered. The depression can have here an approximately rectangular cross-section with a width and/or a height of 0.5 to 6 cm, e.g. 1 cm, 3 cm or 5 cm. The cross-section can, however, also have any other shape with a similar area.

The ducts for the temperature control medium can therefore be produced in a simple manner on the exterior of the cylinder body. Hereby, substantially all restrictions for the geometry of the cooling path which are given through the use of bore holes are eliminated. It is possible in particular to provide far longer cylinder segments from the exterior with depressions than is possible by means of bores. Hereby it is possible to produce the entire extrusion cylinder from one piece or from only a few segments. This permits the number of pins provided for the mixing/plasticizing to be increased, whereby the quality of the extrudate is increased.

In addition, with external production of the temperature control ducts as depressions in the cylinder outer wall, the course of the ducts can be substantially freely determined. Thus, the depressions can run e.g. in a spiral shape around the cylinder. Hereby, it is possible to produce clearly defined flow paths for the cooling or heating medium, in which only a small pressure drop occurs. This facilitates the setting of the cylinder body to a particular temperature.

Although the above-mentioned advantages are already achieved through just the provision of the coverable depression, the extrusion cylinder can also have cover elements which are connected with the outer wall of the cylinder body in such a way that they cover the at least one depression. This permits the cooling or heating medium to be conducted through the depression. Preferably, the covering takes place by the welding of sheet metal onto the upwardly open side of the depression. The cylinder body, provided with the depressions, can, however, also be inserted into a sleeve, e.g. a sheet-metal sleeve, which e.g. owing to press fit, closes all the depressions in a tight manner. Entries and exits for the cooling or heating medium can then be opened in the sleeve.

The at least one depression can have straight segments which run parallel to a longitudinal axis of the cylinder body, and curved segments which produce a connection between two ends, lying in an adjacent manner, of precisely two straight segments. Through the connection of straight elements and curved elements, thereby a flow path can be defined without branches.

The depression therefore runs as it were “in serpentine lines” around the cylinder body. Proceeding from an inlet point for the cooling or heating medium, the depression runs firstly in axial direction. At the end if this straight segment a curved segment adjoins, which leads the depression in circumferential direction of the cylinder body in such a manner that no pressure losses occur. The radius of the curved segments can amount here to 1 to 6 cm, e.g. 2 cm, 3 cm, 4 cm or 5 cm. At the end of the curved segment, a straight segment adjoins again, which runs back in axial direction. This change of curved and radial segments is continued up to an outlet of the cooling or heating medium, preferably in such a manner that the depression includes the entire circumference of the cylinder body like a sleeve. In this way, a flow path can be defined in a simple manner, which permits an optimum temperature control of the cylinder body without excessive pressure losses.

The straight segments can extend out from at least one edge region of the cylinder body and a portion of the curved segments can be arranged in the edge region of the cylinder body. This permits e.g. the cooling or heating medium to be fed in from the edge of the cylinder body. The width of the edge region from the end of the cylinder body can amount to e.g. a thirtieth, a twentieth, a tenth or a fifth of the total length of the cylinder body.

The extrusion cylinder can have, furthermore, at least one connection flange which is mounted by means of press-fit onto the edge region of the cylinder body in such a manner that it covers at least the curved segments which are situated in the edge region. The connection flange itself can therefore serve as a cover element. Hereby, the material consumption can be reduced. The connection flange here can be both a flange for connecting several cylinder body segments, therefore also a flange for connecting with an inlet or outlet of the extrudate into the extrusion cylinder. The extrusion cylinder can therefore be used both in a conventional manner as a segment of a longer cylinder, therefore also as an individual extrusion cylinder. The decision regarding the use or respectively the length of the cylinder is, however, no longer limited here by the technical circumstances, but rather only by the requirements of the operator of the extrusion system which contains the cylinder.

The connection flange can have ducts which make it possible to conduct cooling or heating medium into the depression and out from the depression. In this way, the feeding and discharging of cooling or heating medium can be guaranteed in a simple manner, without further components being necessary.

The straight segments can extend out from the edge region of the cylinder body by a predetermined length which is smaller than the length of the cylinder body. For example, the straight segments can have only three quarters, two thirds, half, one third or one quarter of the total length of the cylinder body. The corresponding depression is then suitable for controlling the temperature of this length region of the cylinder body. Hereby, therefore, a flexible temperature setting of the cylinder body can be achieved.

The straight segments can also not reach to the edge regions of the cylinder body. This means that the depression runs e.g. only in the central region of the cylinder body. The depression can also be e.g. a sixth, quarter, or third of the total length of the cylinder body away from one or both ends of the cylinder body. This allows a central part of the cylinder body to be temperature-controlled separately. Hereby also a flexible temperature setting can be achieved.

At least two connection sites for the directing in and out of cooling or heating medium into the depression can be arranged on the cylinder body. The feeding and discharging of cooling or heating medium therefore does not have to take place via the edge regions of the cylinder body, but rather can be carried out basically everywhere on the cylinder body. It is also possible e.g. to use as a connection site a bore of a flange which is mounted on the end of the cylinder body, and to arrange a further connection site of the same temperature control medium duct on the cylinder body. This also permits a more flexible temperature setting.

The outer wall of the cylinder body can have a plurality of depressions which are not connected with one another and which in the covered state define respectively their own flow path for cooling or heating medium. This permits various, non-communicating temperature control circuits to be provided, which can set the cylinder body in their region to different temperatures. Hereby also a more flexible temperature setting is made possible.

The cylinder body can have a plurality of radial bore holes which are suitable for receiving pins or screws. The bore holes can be arranged at other locations than the at least one depression. An extrusion cylinder which is able to be temperature-controlled in a simple manner can in this way also be occupied by pins, screws, bolts or suchlike which project into the passage region for the extrudate and thus promote the plasticizing and mixing of the extrudate. The boreholes which are provided for this can be distributed over the entire surface of the extrusion cylinder, so that a uniform action on the extrudate is made possible. If the boreholes do not overlap with the depressions, i.e. the channels for the cooling or heating medium, a simple interchanging of the pins or screws sunken therein is possible without having to interrupt the temperature control circuit. On the other hand, it is also possible, after inserting of the screws, to close the bore holes in a tight manner against the temperature control medium so that, if necessary, they can also be arranged in the region of the depression.

An extrusion device can have an extrusion cylinder, as was described above, the at least one depression of which is covered. In addition, the extrusion device can have cooling or heating medium which runs in the at least one covered depression. Hereby, the advantages which were explained above are realized in operation of an extrusion device.

Furthermore, the extrusion device can have respectively a temperature controlling arrangement for each depression, which is suitable for controlling the temperature of the cooling or heating medium running in the respective depression. Therefore an extrusion with the use of an extrusion cylinder which is able to be set to different temperature zones is possible.

A production method for an extrusion cylinder as was described above can comprise: producing the at least one depression in an outer wall of the cylinder body, for instance by milling. The production method can furthermore comprise: covering the at least one depression with a cover element, for instance with sheet metal. This enables the simple production of the extrusion cylinder by means of standard methods.

The present invention is described in detail below with reference to the figures. This description is purely by way of example. The invention itself is only determined by the subject of the claims. There are shown:

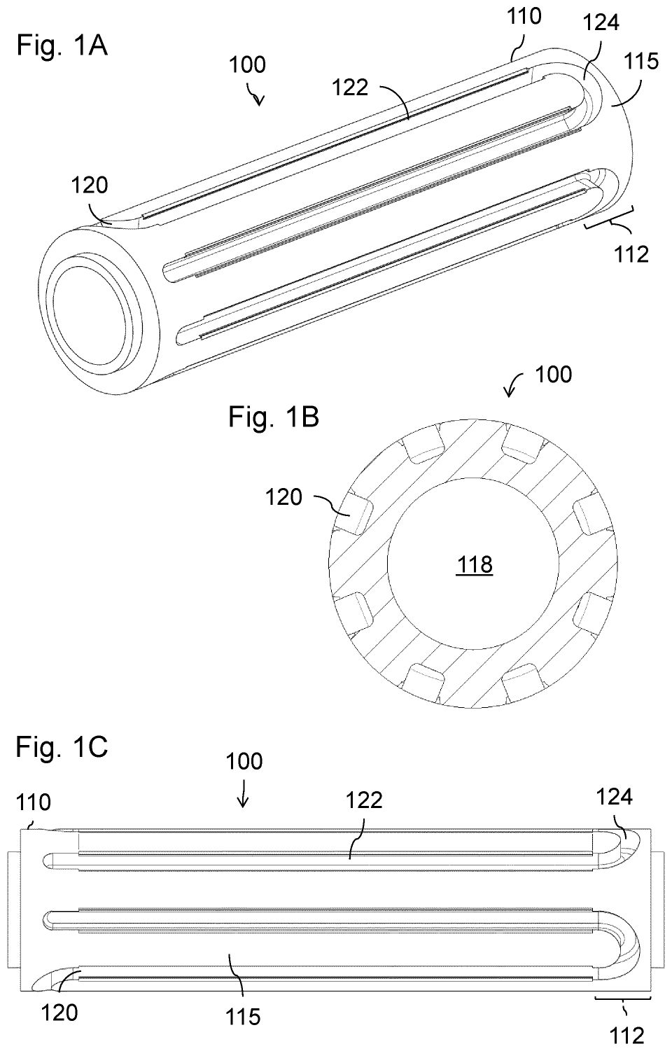

FIG. 1A to 1C various schematic views of an extrusion cylinder;

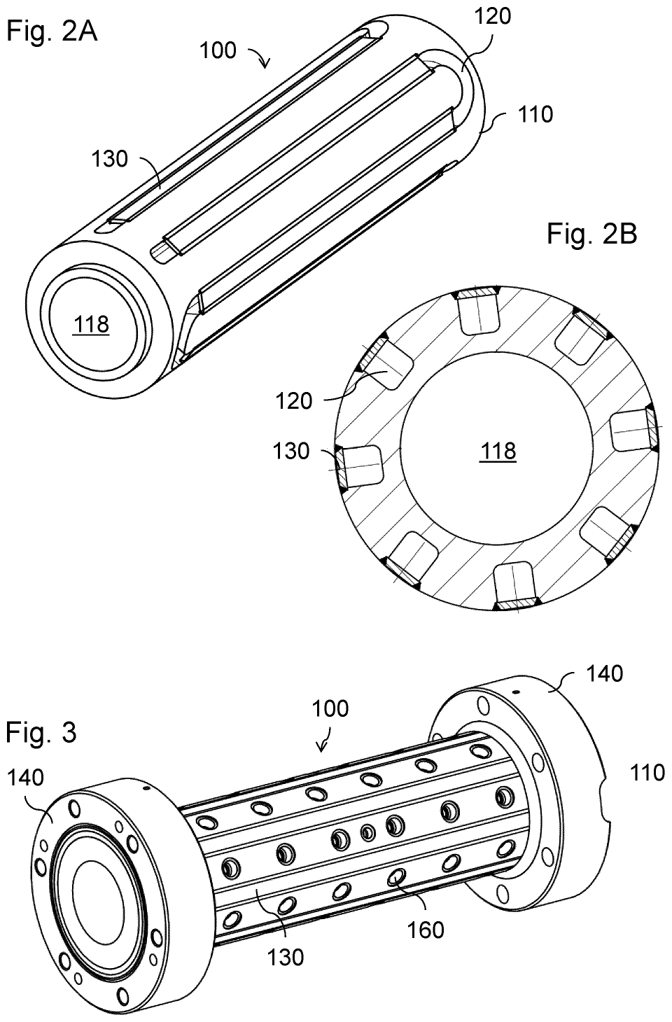

FIGS. 2A and 2B various schematic views of a further extrusion cylinder;

FIG. 3 a schematic view of a further extrusion cylinder;

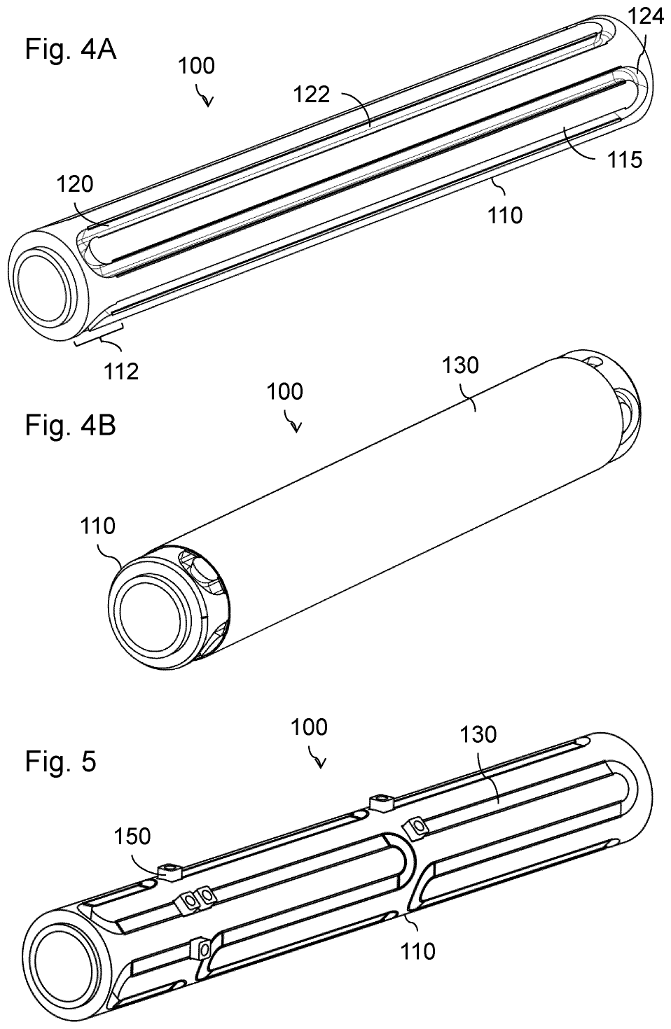

FIGS. 4A and 4B various views of further extrusion cylinders;

FIG. 5 a schematic view of a further extrusion cylinder;

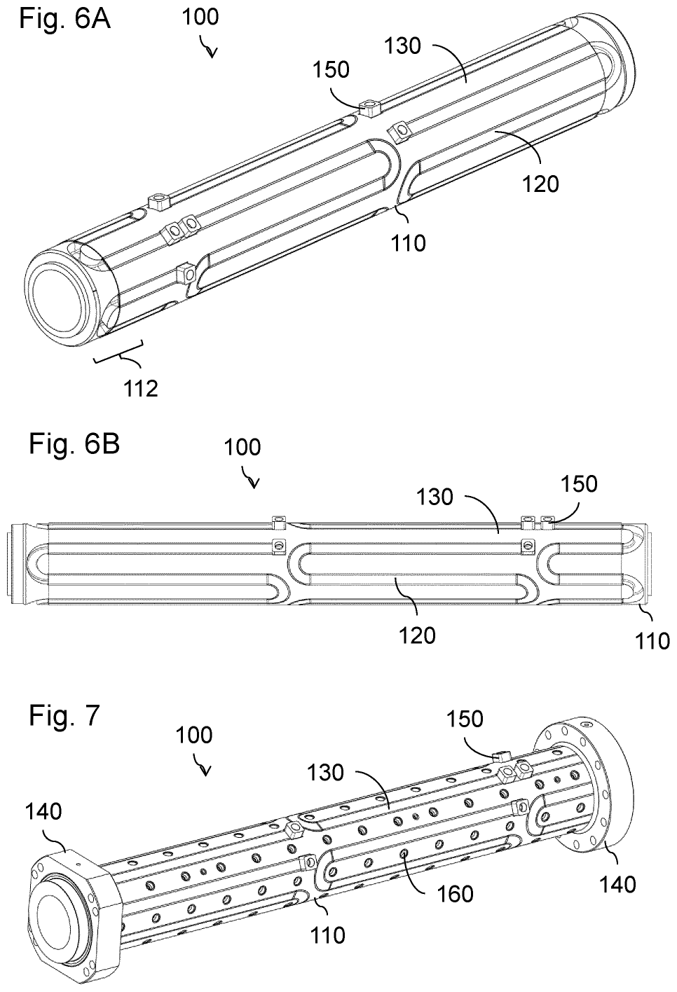

FIGS. 6A and 6B schematic views of a further extrusion cylinder;

FIG. 7 a schematic view of a further extrusion cylinder; and

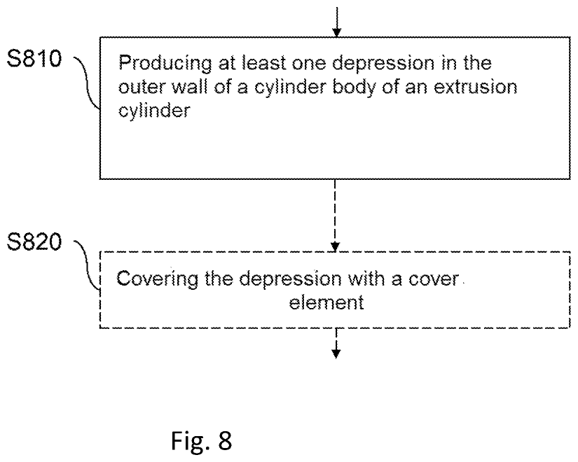

FIG. 8 a schematic flowchart for a production method of an extrusion cylinder.

FIG. 1A to 1C show various schematic views of an extrusion cylinder 100. FIG. 1A shows an oblique view, FIG. 1B a cross-section through the extrusion cylinder 100 and FIG. 1C a side view of the extrusion cylinder 100.

The extrusion cylinder 100 consists substantially of a cylinder body 110, preferably manufactured from metal, which is configured as a hollow cylinder. The cylinder body 110 has an outer wall 115, which corresponds to the external covering surface of the hollow cylinder. In the inside of the cylinder body 110 an interior 118 exists, which serves to receive an extruder worm and is suitable for the conducting, plasticizing and mixing of an extrudate, such as e.g. rubber, caoutchouc or suchlike.

The dimensions of the extrusion cylinder 100 correspond here to the dimensions usually used for extrusion and are substantially dependent on the material which is to be extruded. Typical dimensions for the total length of an extrusion cylinder for rubber extrusion lie approximately in the range of 1 to 5 metres and can therefore amount to e.g. 1 m, 2 m, 3 m, 4 m or 5 m. However, longer extrusion cylinders are also conceivable.

The extrusion cylinder 100 can have a length which corresponds to the entire length required for the extrusion. The extrusion cylinder 100 can, however, also be a segment of the total extrusion cylinder, which is then composed of several extrusion cylinders. One or more of these cylinders can correspond to the extrusion cylinder 100 or the modifications of this cylinder which are discussed further below.

Typical dimensions for rubber extrusion for the outer radius of the cylinder body 110 lie in the range of 20 to 50 cm, e.g. 25 cm, 30 cm, 35 cm, 40 cm or 45 cm. Possible inner radii lie in the range of 4.5 cm to 30 cm, e.g. 5 cm, 10 cm, 15 cm, 20 cm or 25 cm. The wall thickness of the cylinder body 110 therefore lies in the range of 3 cm to 10 cm, e.g. 5 cm or 7 cm. A ratio of length to diameter can lie e.g. between 10:1 and 3:1, e.g. at ca. 4:1, 6:1, 7:1 or 8:1.

The cylinder body 110 has in its outer wall 115 at least one depression 120. As shown in FIG. 1A to 1C, this can concern here a single continuous depression 120, which runs around the entire cylinder body 110. The depression 120 is configured here, in particular with respect to its width and depth, in such a manner that a cooling or heating medium, designated in the following as temperature control medium, such as for instance water or suchlike, can flow unimpeded, i.e. without excessive pressure loss, through the depression 120. In addition, by the depression in the direction along the outer wall 115 of the cylinder body 110 a flow path is to be defined, which is as far as possible free of branches or through the flow parameter of the temperature control medium—and hence a heat exchange with the cylinder body 110—can be controlled or regulated in an uncomplicated manner, e.g. through the placing of a valve or the conveying capacity of a pump.

As shown in FIG. 1B, the depression 120 can have a depth for this which corresponds to more than half of the wall thickness of the cylinder body 110. The width of the depression can correspond here to approximately its depth but can also differ therefrom. For example, with a wall thickness of approximately 5 cm, the width of the depression 120 can lie in the range of approximately 2 cm to 4 cm, e.g. at 3 cm. The depth of the depression 120 then likewise lies in the range of 2 cm to 4 cm, e.g. likewise at 3 cm or at 3.5 cm. With another wall thickness of the cylinder body 110, the said dimensions for the depression 120 can either remain the same or be adapted proportionally. Instead of the cross-section shape of the depression 120 shown in FIG. 1B, this can also have any other cross-section which is easy to produce, such as e.g. a triangular shape or the shape of a circle segment, for instance a semi-circular shape.

As shown in FIGS. 1A and 1C, the depression 120 can be composed of straight segments 122 and curved segments 124. The straight segments 122 run here axially along the outer wall 115 of the cylinder body 110. They can, as shown, extend out from an edge region 112 of the cylinder body 110, e.g. up to the opposite edge region. In the edge regions 112 the curved segments 124 are arranged. These connect respectively adjacent ends of precisely two straight segments 122 with one another. As the curved segments 124 are arranged respectively alternately in the one or the other edge region 112, the depression 120 has a branch-free course. This means that a temperature control medium can be conducted in a clearly defined manner from the beginning of the depression 120 to its end.

In the region of the straight segments 122 a flow of the temperature control medium is exposed to almost no resistance. Here, substantially only the resistance due to the friction on the walls of the depression 120 exists. The pressure loss along the straight segments 122 is therefore relatively small.

The depression 120 is also configured in the edge regions 112 of the cylinder body 110 without abrupt transitions or edges. Thereby, the flow resistance on transition between two straight segments 122 remains low. As shown, the curved segments 124 which are used for this can be configured as circular arcs. The radii of the curved segments 124 are selected in such a way that the flow resistance is minimized. The radii can lie here in the range of 1 cm to 10 cm, depending on the size of the cylinder body. For example, with an external diameter of approximately 25 cm, radii of e.g. 1 cm, 1.5 cm or 2 cm can be used, whereas with an external diameter of approximately 40 cm radii of 3 cm, 5 cm or 7 cm are possible.

The course of the depression 120 shown in FIG. 1A to 1C (or in the figures described further below) is to be regarded here as purely by way of example. Basically any desired course forms of the depression 120 are conceivable, such as e.g. a spiral-shaped circulation with constant or varying spiral pitch. The crucial factor for the shape or respectively the course of the depression is solely that thereby an easy controlling or respectively regulating of the temperature control of the cylinder body 110 is possible and that pressure losses of a temperature control medium flow are kept as small as possible. This allows the cylinder body 110, and hence the extrusion cylinder 100, to be able to be temperature-controlled in a simple manner without excessive expenditure.

The depression 120 can be introduced here in any suitable manner for this into the outer wall 115 of the cylinder body 110. Preferably, the depression 120 is milled into the cylinder body 110. This permits a particularly simple production of the extrusion cylinder 100. The depression 120 can, however, also be produced differently, e.g. by means of an etching method, by grinding, by a cast semi-finished product including the depressions or suchlike.

The depression 120 of the extrusion cylinder 100, described with reference to FIG. 1A to 1C, specifies the basic structure for channels for the conducting of temperature control media. In order to form these channels, as illustrated schematically in FIGS. 2A, 2B and 3, cover elements 130 are connected with the outer wall 115 of the cylinder body 110, through which the depression 120 is closed in a tight manner. All the cover elements 130 together only free inlet and outlets here which are suitable for the introducing of the temperature control medium into the depression 120.

As shown in FIGS. 2A and 2B, in particular parts of the depression which are not arranged within the edge regions 112 of the cylinder body 110 can be closed by cover elements 130 formed in the shape of the depression 120. In particular, these segments of the depression 120 can be closed by metal sheets which are brought into corresponding shape, e.g. stamped, which are welded at the edges of the depression 120 with the cylinder body 110. However, other perfectly fitting cover elements 130 are also conceivable, e.g. plastic coverings. In addition, it is also possible to fasten the cover elements 130 differently, e.g. by screwing, bonding or a combination thereof. If necessary, sealing means can be provided between cover elements 130 and the cylinder body 110, in order to create tight channels for the temperature control medium.

As shown in FIG. 3, the segments of the depression, which are arranged in edge regions 112 of the cylinder body 110, can be covered by means of connection flanges 140, which are connected e.g. by means of press-fit with the cylinder body 110. Through the press fit, the segments are closed in the edge regions 112 in a tight manner. If, in addition, the cover elements 130 in the centre region of the cylinder body 110 extend into the edge regions 112, a tight closure of the depression 120 can be achieved without further sealing.

This is shown by way of example in FIG. 3, in which the straight segments 122 of the depression 120, as shown in FIG. 2A, are closed by cover elements 130, e.g. welded-on metal sheets, while the curved segments 124 are sealed by the connection flanges 140 applied by mans of press fit. The connection flanges 140 also overlap here a portion of the straight segments 122. Hereby, in a simple manner a closure of the depression 120 is achieved.

The connection flanges 140 can be configured here in such a way that they enable a combination of several extrusion cylinders 100 to a total cylinder. They can, however, also represent the connection elements which serve for the connecting of the extrusion cylinder 100 to the extrudate feed and the output of the extrusion device, in which the extrusion cylinder 100 is used.

Feeds and discharges can be arranged here at any desired location on the cylinder body 110 or through the connection flanges 140. For the feeding of the temperature control medium in the central region of the cylinder body 110, a portion of the depression 120 must remain unclosed for this, or respectively the cover element 130 must be removed again at this location or drilled out. This involves a certain effort, but permits a simple and free positioning of feed points. With feed via the connection flanges 140, these must have corresponding bores which with the press fit come to lie over the desired free regions of the depression 120 in the edge regions 112. When corresponding connection flanges 140 are available, the feed of temperature control medium can thus be produced without a further processing step.

Instead of the connection flanges 140 shown in FIG. 3, cover elements 130, as are used in the central region of the cylinder body 110, can also be used in the edge regions 112 of the cylinder body 110 for closing the depression 120. The closure then takes place in a uniform manner and is independent of the use of connection flanges 140.

As shown in FIGS. 4A and 4B, instead of the perfectly fitting covering of the depression 120, a cover element 130 can also be used which surrounds the entire cylinder body 110. For example, a round metal sheet or a tube can be pushed by means of press fit over the cylinder body 110, which then rests on the cylinder body 110 in a tight manner in such a way that the region of the depression 120 which is situated under the cover element 130 is closed in a tight manner. As shown in FIG. 4B, the cover element 130 can leave the edge regions 112 of the cylinder body 110 free. These can, however, also be covered.

In FIG. 5 to 7 variants of the extrusion cylinder 100 are shown, in which a plurality of depressions 120 is present. The examples which are shown have respectively three depressions 120 which are not in connection. However, any number of depressions 120 is possible. The depressions 120 surround a respective region of the cylinder body 110 like a sleeve. They therefore surround a portion of the cylinder body 110 with a length which is smaller than the total length of the cylinder body 110, entirely in circumferential direction of the cylinder body 110. Through such depressions 120, which can basically also be configured differently to that shown by way of example in FIG. 5 to 7, various temperature control circuits can be defined. Thereby, the extrusion cylinder 100 can be divided into various temperature zones, if this were to be necessary for the optimization of the extrusion process. In particular, depressions 120 and hence temperature zones can be produced, which do not lie in the edge regions 112 of the cylinder body 110. It shall be understood that such a division into various temperature zones can also take place in circumferential direction. Then, a plurality of depressions 120 is necessary, in order to run around the cylinder body 110 in circumferential direction.

In an extrusion device which uses one of the extrusion cylinders 100 described above, then to regulate the temperature of each zone of the cylinder body 110 which is run through by a depression 120 its own temperature control unit can be provided. This enables the temperature to be set entirely freely along the extrusion cylinder with corresponding selection of the course of the depressions 120, whereby the quality of the extrudate can be improved.

As shown in FIG. 5 to 7, the extrusion cylinder 100 can have a plurality of connection sites 150, via which the temperature control medium can be fed and discharged. These connection sites 150 are positioned on the cylinder body 110 at the beginning and at the end respectively of a depression 120. The remaining regions of the depressions 120 are closed by means of cover elements 130. As explained above, these can be configured in a perfectly fitting manner (FIGS. 5 and 7) or—according to the variant described with reference to FIG. 4B—as a sleeve completely surrounding the cylinder body 110 (FIGS. 6A and 6B, the sleeve is shown here transparently, in order to illustrate the depressions 120 lying therebeneath). In the first case, the connection sites 150 can be simply applied, e.g welded, screwed or bonded, onto regions of the depression which remain free. In the second case, the cover elements 130 are opened at the desired sites and the connection sites 150 are then applied. With a termination of the extrusion cylinder 100 by means of connection flanges 140, as is shown in FIG. 7, a portion of the feeding can also take place via the connection flanges 140. Through all these variants, a feed of the temperature control medium which is flexible and tailored to requirements is possible.

As shown in FIGS. 3 and 7, the extrusion cylinder 100 can have a plurality of boreholes 160, which entirely penetrate the hollow cylinder, i.e. which produce a connection between the interior 118 and the exterior of the cylinder body 110. Pins, screws, bolts or suchlike can be inserted into such boreholes 160, which project into the interior 118 and there, during the operation, improve the plasticizing and the mixing of the extrudate as additional friction points. This takes place in an effective manner with as uniform a distribution of the boreholes 160 as possible.

Owing to the free distributability of the depressions 120, which results from the simple production method of these depressions 120, e.g. by milling, the boreholes 160 can also be distributed uniformly over the cylinder body 110. In addition, the production of the temperature control medium channels from the exterior permits larger segments of the total extrusion cylinder to be produced from one piece. With corresponding configuration of the system which is used for the production of the depression 120, extrusion cylinders 100 can also be manufactured which can be used as total extrusion cylinders. This reduces the number of connection flanges arranged on the length of the cylinder course. As no boreholes 160 can be arranged in the region of these flanges, through the use of the extrusion cylinders 100 described above the number of boreholes 160 and hence the number of pins promoting the plasticizing and mixing of the extrudate can be increased compared to conventional extrusion cylinders. The quality of the extrudate is thereby improved.

Owing to the easier accessibility, the boreholes 160 are preferably not formed in regions in which the depression 120 runs. However, it is also possible that depressions 120 and boreholes 160 overlap one another. With corresponding sealing of the pins, inserted into the boreholes 160, against the temperature control medium, this does not present a fundamental problem. The boreholes 160 can therefore basically be distributed entirely freely over the cylinder body 110.

FIG. 8 shows a schematic flowchart for a production method of one of the extrusion cylinders described above. In a crucial method step S810 for the production process, a depression is introduced into the outer wall of an extrusion cylinder suitable for the extrusion, in particular of rubber, which in the covered state is suitable for the conducting of temperature control medium. This preferably takes place by milling the depression into the covering surface of a hollow cylinder forming the extrusion cylinder. Optionally, at S820 subsequently the depression can be covered by means of cover elements, preferably by welding-on or pressing-on of a metal sheet.

In this way, temperature control medium channels for controlling the temperature of the extrusion cylinder can be introduced into the extrusion cylinder in a flexible, simple and less error-prone manner. As the method is applied from the exterior, it is possible to produce extrusion cylinders with greater lengths than is known from the prior art. Hereby, the production- and installation expenditure of extrusion devices which use such extrusion cylinders is reduced. In addition, it is possible to produce clearly defined flow channels for the temperature control medium, which simplify and make more flexible a temperature control of the extrusion cylinder. Finally, owing to the increased length, the number of pins for the plasticizing and mixing of extrudate which is conducted in the extrusion cylinder can be increased, whereby the quality of the extrudate can be improved.

### LIST OF REFERENCE NUMBERS

100 extrusion cylinder
110 cylinder body
112 edge region of the cylinder body
115 outer wall of the cylinder body
118 interior of the cylinder body
120 depression
122 straight segment of the depression
124 curved segment of the depression
130 cover element
140 connection flange
150 connection site
160 boreholes

What is claimed is:

1. An extrusion cylinder (100) with a cylinder body (110) for accommodating an extruder worm, wherein
an outer wall (115) of the cylinder body (110) has at least one depression (120) which can be covered and which in the covered state is suitable for conducting a cooling or heating medium for controlling the temperature of the cylinder body (110), wherein
the at least one depression (120) has straight segments (122), which run parallel to a longitudinal axis of the cylinder body (110), and curved segments (124), which produce a connection between two ends, lying adjacent, of precisely two straight segments (122); and
through the connection of straight segments (122) and curved segments (124) a flow path without branches is defined,
furthermore with cover elements (130) which are connected with the outer wall (115) of the cylinder body (110) in such a manner that they cover the at least one depression (120).

2. (canceled)

3. (canceled)

4. The extrusion cylinder (100) according to claim 1g-, wherein the straight segments (122) extend out from at least one of the edge regions (112) of the cylinder body (110) and a portion of the curved segments (124) is arranged in the edge region (112) of the cylinder body (110).

5. The extrusion cylinder (100) according to claim 4, furthermore with at least one connection flange (140), which is applied by means of press fit onto the edge region (112) of the cylinder body (110) in such a manner that it covers at least the curved segments (124) which are situated in the edge region (112).

6. The extrusion cylinder (100) according to claim 5, wherein the connection flange (140) has ducts which make it possible to conduct cooling or heating medium into the depression (120) and out from the depression (120).

7. The extrusion cylinder (100) according to claim 4, wherein
the straight segments (122) extend out from the edge region (112) of the cylinder body (110) by a predetermined length which is smaller than the length of the cylinder body (110).

8. The extrusion cylinder (100) according to claim 4, wherein the straight segments (122) do not reach the edge regions (112) of the cylinder body (110).

9. The extrusion cylinder (100) according to claim 7, wherein on the cylinder body (110) at least two connection sites (150) are arranged for the conducting in and out of cooling or heating medium into the depression (120).

10. The extrusion cylinder (100) according to one of the preceding claim 1, wherein
the outer wall (115) of the cylinder body (110) has a plurality of the depressions (120), which are not connected with one another and which in the covered state define respectively their own flow path for cooling or heating medium.

11. The extrusion cylinder (100) according to claim 1, wherein
the cylinder body (110) has a plurality of radial boreholes which are suitable for receiving pins or screws and which are arranged at different sites than the at least one depression (120).

12. An extrusion device with an extrusion cylinder (100) according to claim 1, wherein the at least one depression (120) is covered; and
cooling or heating medium, which runs in the at least one covered depression (120).

13. The extrusion device according to claim 12, furthermore with respectively a temperature controlling arrangement for each depression (120), for controlling the temperature of the cooling or heating medium running in the respective depression (120).

14. A production method for an extrusion cylinder (100) according to claim 1, with comprising the step:
producing the at least one depression (120) in the outer wall (115) of the cylinder body (110).

15. The production method according to claim 14, furthermore h comprising the step:
covering the at least one depression (120) with a cover element (130).
